(19) United States
(12) Patent Application Publication
(10) Pub. No.: US 2012/0026040 A1
(43) Pub. Date: Feb. 2, 2012

(54) Method, Apparatus, Computer Program and a Computer Readable Storage Medium

(76) Inventors: Thomas Hohne, Helsinki (FI); Klaus Doppler, Berkeley, CA (US); Ari Hottinen, Espoo (FI); Vuokko Nurmela, Espoo (FI)

(21) Appl. No.: 13/128,764

(22) PCT Filed: Nov. 12, 2008
(86) PCT No.: PCT/EP2008/065426

§ 371 Date: Aug. 16, 2011

(51) Int. Cl. H01Q 3/26

(52) U.S. Cl. 342/372

(57) ABSTRACT

A method including calculating a parameter for controlling a main lobe of a radiation pattern of an antenna array, the calculation using a direction of a location relative to the antenna array, the direction determined from information including a position of the location; determining a parameter for controlling the main lobe of the radiation pattern of the antenna array from a signal received at the antenna array from the location; and determining an offset using the parameter calculated from the determined direction and the parameter determined from the received signal.

### FIELD OF THE INVENTION

Embodiments of the present invention relate to a method, apparatus, computer program and a computer readable storage medium. In particular, they relate to a method, apparatus, computer program and a computer readable storage medium in a base station.

### BACKGROUND TO THE INVENTION

Apparatus, such as base stations, usually include a transceiver and an antenna array for communicating with other apparatus, such as mobile cellular telephones. The antenna array includes a plurality of antennas which, through constructive and destructive interference, form a radiation pattern having one or more main lobes.

When the base station is initially set up, it may require calibration so that it may accurately orient the main lobe towards another apparatus and thereby efficiently transmit signals to, and/or receive signals from the other apparatus. Usually, base stations are calibrated using dedicated hardware which is relatively expensive.

It would therefore be desirable to provide an alternative apparatus.

### BRIEF DESCRIPTION OF VARIOUS EMBODIMENTS OF THE INVENTION

According to various, but not necessarily all, embodiments of the invention there is provided a method comprising: calculating a parameter for controlling a main lobe of a radiation pattern of an antenna array, the calculation using a direction of a location relative to the antenna array, the direction determined from information including a position of the location; determining a parameter for controlling the main lobe of the radiation pattern of the antenna array from a signal received at the antenna array from the location; and determining an offset using the parameter calculated from the determined direction and the parameter determined from the received signal.

The method may further comprise calibrating an apparatus using the determined offset.

The method may be for calibrating a receiver and/or a transmitter of an apparatus.

According to various, but not necessarily all, embodiments of the invention there is provided an apparatus comprising: a processor configured to: calculate a parameter, for controlling a main lobe of a radiation pattern of an antenna array, using a direction of a location relative to the antenna array, the direction determined from information including a position of the location; to determine a parameter for controlling the main lobe of the radiation pattern of the antenna array from a signal received at the antenna array from the location; and to determine an offset using the parameter calculated from the determined direction and the parameter determined from the received signal.

The apparatus may be for wireless communication.

The processor may be configured to calibrate the apparatus using the determined offset.

According to various, but not necessarily all, embodiments of the invention there is provided a module comprising an apparatus as described in the above paragraph.

According to various, but not necessarily all, embodiments of the invention there is provided an electronic device comprising an apparatus as described in the above paragraph.

According to various, but not necessarily all, embodiments of the invention there is provided a computer program that, when run on a computer, performs: calculating a parameter for controlling a main lobe of a radiation pattern of an antenna array, the calculation using a direction of a location relative to the antenna array, the direction determined from information including a position of the location; determining a parameter for controlling the main lobe of the radiation pattern of the antenna array from a signal received at the antenna array from the location; and determining an offset using the parameter calculated from the determined direction and the parameter determined from the received signal.

The computer program may perform, when run on a computer, calibrating an apparatus using the determined offset.

According to various, but not necessarily all, embodiments of the invention there is provided a computer program that, when run on a computer, performs the method described in the above paragraph.

According to various, but not necessarily all, embodiments of the invention there is provided a computer readable storage medium encoded with instructions that, when executed by a processor, perform: calculating a parameter for controlling a main lobe of a radiation pattern of an antenna array, the calculation using a direction of a location relative to the antenna array, the direction determined from information including a position of the location; determining a parameter for controlling the main lobe of the radiation pattern of the antenna array from a signal received at the antenna array from the location; and determining an offset using the parameter calculated from the determined direction and the parameter determined from the received signal.

The computer readable storage medium may be encoded with instructions that, when executed by a processor perform calibrating an apparatus using the determined offset.

According to various, but not necessarily all, embodiments of the invention there is provided an apparatus comprising: means for calculating a parameter for controlling a main lobe of a radiation pattern of an antenna array, the calculation using a direction of a location relative to the antenna array, the direction determined from information including a position of the location; means for determining a parameter for controlling the main lobe of the radiation pattern of the antenna array from a signal received at the antenna array from the location; and means for determining an offset using the parameter calculated from the determined direction and the parameter determined from the received signal.

According to various, but not necessarily all, embodiments of the invention there is provided a method comprising: determining a direction of a location relative to an antenna array, using information including a position of the location; and controlling a main lobe of a radiation pattern of the antenna array using the determined direction.

According to various, but not necessarily all, embodiments of the invention there is provided an apparatus comprising a processor configured to determine a direction of a location relative to an antenna array, using information including a position of the location; and controlling a main lobe of a radiation pattern of the antenna array using the determined direction.

### BRIEF DESCRIPTION OF THE DRAWINGS

For a better understanding of various examples of embodiments of the present invention reference will now be made by way of example only to the accompanying drawings in which:

FIG. 1 illustrates a schematic diagram of an apparatus according to various embodiments of the present invention and a further apparatus;

FIG. 2 illustrates a flow diagram of a method of calibrating a receiver according to various embodiments of the present invention;

FIG. 3 illustrates a flow diagram of a method of calibrating a transmitter according to various embodiments of the present invention;

FIG. 4 illustrates a schematic diagram of a system including an apparatus according to various embodiments of the present invention;

FIG. 5 illustrates a schematic diagram of another system including an apparatus according to various embodiments of the present invention; and

FIG. 6 illustrates a schematic diagram of a further system including an apparatus according to various embodiments of the present invention.

### DETAILED DESCRIPTION OF VARIOUS EMBODIMENTS OF THE INVENTION

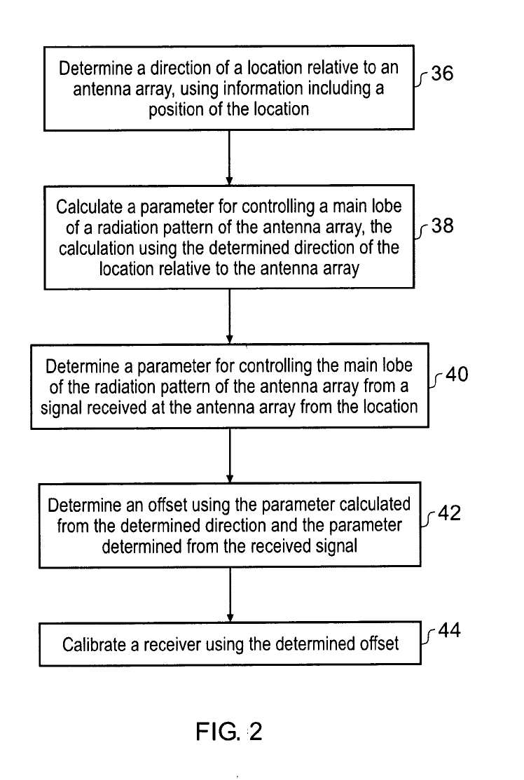

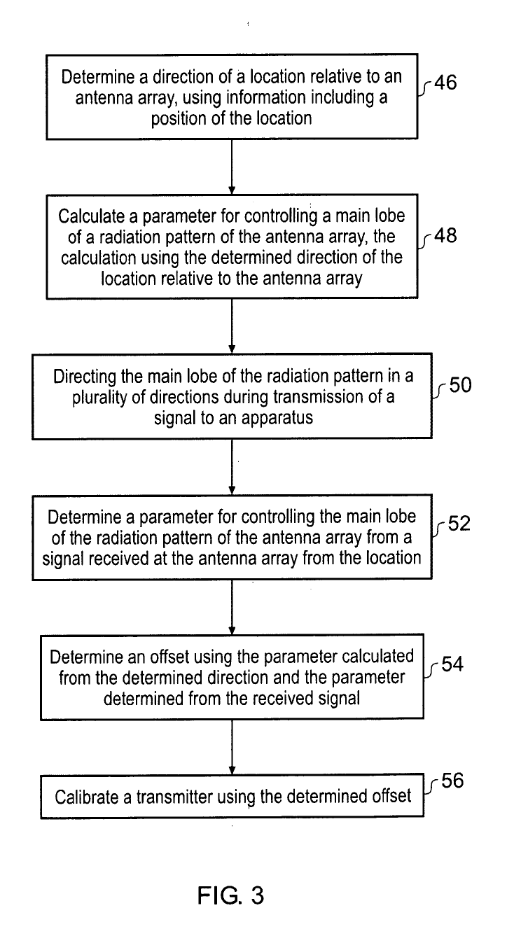

FIGS. 2 and 3 illustrate a method comprising: calculating a parameter for controlling a main lobe 32 of a radiation pattern 30 of an antenna array 18, the calculation using a direction of a location relative to the antenna array 18, the direction determined from information 28 including a position of the location; determining a parameter for controlling the main lobe 32 of the radiation pattern 30 of the antenna array 18 from a signal received at the antenna array 18 from the location; and determining an offset using the parameter calculated from the determined direction and the parameter determined from the received signal.

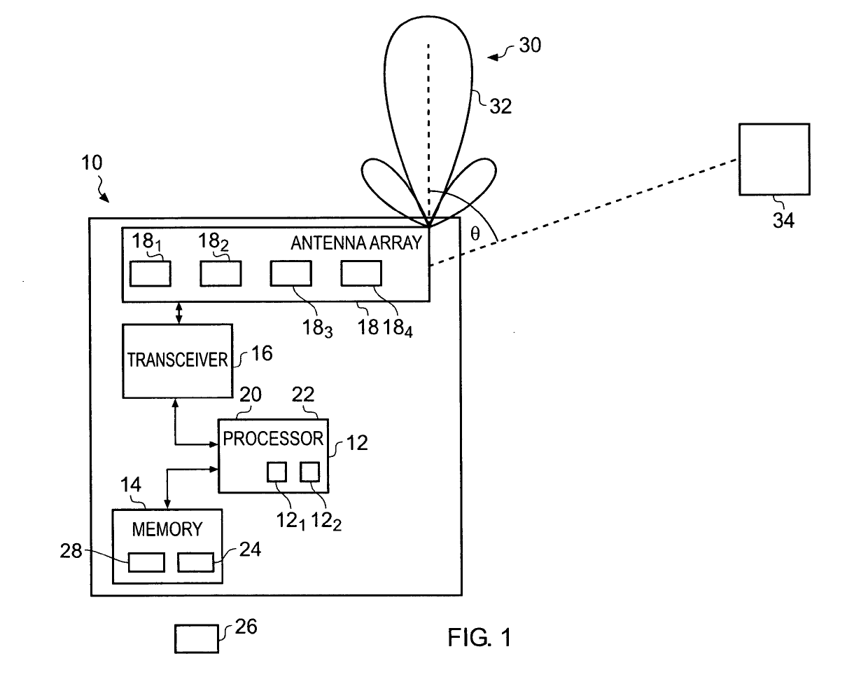

FIG. 1 illustrates a schematic diagram of an apparatus 10 according to various embodiments of the present invention. The apparatus 10 includes a processor 12, a memory 14, a transceiver 16 and an antenna array 18.

In the following description, the wording ‘connect’ and ‘couple’ and their derivatives mean operationally connected/coupled. It should be appreciated that any number or combination of intervening components can exist (including no intervening elements). Additionally, it should be appreciated that the connection/coupling may be a physical galvanic connection and/or an electromagnetic connection.

The apparatus 10 may be any electronic device and may be a base station for a cellular network (also referred to as a radio base station (RBS) or a base transceiver station (BTS) in the art) or a module for such a device. As used here, ‘module’ refers to a unit or apparatus that excludes certain parts/components that would be added by an end manufacturer or a user. For example, a module may not include the antenna array 18.

The electronic components that provide the processor 12, the memory 14, and the transceiver 16 may be interconnected via a printed wiring board (PWB). In various embodiments, the printed wiring board 22 may be a flexible printed wiring board.

The implementation of the processor 12 can be in hardware alone (e.g. a circuit etc), have certain aspects in software including firmware alone or can be a combination of hardware and software (including firmware). The processor 12 may be any suitable processor and may include a microprocessor 12₁ and memory 12₂. The processor 12 may be implemented using instructions that enable hardware functionality, for example, by using executable computer program instructions in a general-purpose or special-purpose processor that may be stored on a computer readable storage medium (e.g. disk, memory etc) to be executed by such a processor.

The processor 12 is configured to read from and write to the memory 14. The processor 12 may also comprise an output interface 20 via which data and/or commands are output by the processor 12 and an input interface 22 via which data and/or commands are input to the processor 12.

The memory 14 may be any suitable memory and may, for example be permanent built-in memory such as flash memory or it may be a removable memory such as a hard disk, secure digital (SD) card or a micro-drive. The memory 14 stores a computer program 24 comprising computer program instructions that control the operation of the apparatus 10 when loaded into the processor 12. The computer program instructions 24 provide the logic and routines that enables the apparatus 10 to perform the methods illustrated in FIGS. 2 and 3. The processor 12 by reading the memory 14 is able to load and execute the computer program 24.

The computer program instructions 24 provide: computer readable program means for calculating a parameter for controlling a main lobe of a radiation pattern of an antenna array, the calculation using a direction of a location relative to the antenna array, the direction determined from information including a position of the location; computer readable program means for determining a parameter for controlling the main lobe of the radiation pattern of the antenna array from a signal received at the antenna array from the location; and computer readable program means for determining an offset using the parameter calculated from the determined direction and the parameter determined from the received signal.

The computer program 24 may arrive at the apparatus 10 via any suitable delivery mechanism 26. The delivery mechanism 26 may be, for example, a computer-readable storage medium, a computer program product, a memory device, a record medium such as a CD-ROM, DVD or Blu-Ray Disc, an article of manufacture that tangibly embodies the computer program 24. The delivery mechanism may be a signal configured to reliably transfer the computer program 24. The apparatus 10 may propagate or transmit the computer program 24 as a computer data signal.

Although the memory 14 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single /multi-processor architectures and sequential (e.g. Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memory 14 also stores information 28 relating to locations, objects, topography and other apparatus within communication range of the antenna array 18 (i.e. within the ‘cell’ of the apparatus 10). In particular, the information 28 may include the position (latitude, longitude and height above sea level), size and distance of objects such as buildings and elevated terrain (e.g. hills) within communication range of the antenna array 18. The information 28 may also include the position (latitude, longitude and height above sea level) and distance of locations which are in ‘line of sight’ (LOS) of the antenna array 18. It should be appreciated that other apparatus such as base stations and repeaters may be located at a location which is in ‘line of sight’ of the antenna array 18. Additionally, the information 28 may include propagation channel data for propagation channels formed from topography and objects (such as buildings) in the communication range of the antenna array 18. Furthermore, the information 28 may include the position (latitude, longitude and height above sea level) of the antenna array 18.

The transceiver 16 may be a single unit that provides the functionality of a receiver and/or a transmitter. Alternatively, the transceiver 16 may be a separate receiver and a separate transmitter.

The processor 12 is configured to provide signals to the transceiver 16. The transceiver 16 is configured to receive and encode the signals from the processor 12 and provide them to the antenna array 18 for transmission. The transceiver 16 is also operable to receive and decode signals from the antenna array 18 and then provide them to the processor 12 for processing.

The antenna array 18 may be any antenna array which is suitable for operation in an apparatus such as a base station and includes a plurality of antennas 18₁, 18₂, 18₃, 18₄. It should be appreciated that the antenna array 18 may include any number of antennas and should not be limited to the number of antennas illustrated in FIG. 1. Furthermore, the apparatus 10 may include a plurality of antenna arrays.

The antenna array 18 may have matching components between one or more feeds of the antennas 18₁, 18₂, 18₃, 18₄ and the transceiver 16. These matching components may be lumped components (e.g. inductors and capacitors) or transmission lines, or a combination of both. The antenna array 18 is operable in at least one operational resonant frequency band and may also be operable in a plurality of different radio frequency bands and/or protocols. For example, the different frequency bands and protocols may include (but are not limited to) LTE 700 (US) (698.0-716.0 MHz, 728.0-746.0 MHz), LTE 1500 (Japan) (1427.9-1452.9 MHz, 1475.9-1500.9 MHz), LTE 2600 (Europe) (2500-2570 MHz, 2620-2690 MHz), AM radio (0.535-1.705 MHz); FM radio (76-108 MHz); Bluetooth (2400-2483.5 MHz); WLAN (2400-2483.5 MHz); HLAN (5150-5850 MHz); GPS (1570.42-1580.42 MHz); US-GSM 850 (824-894 MHz); EGSM 900 (880-960 MHz); EU-WCDMA 900 (880-960 MHz); PCN/DCS 1800 (1710-1880 MHz); US-WCDMA 1900 (1850-1990 MHz); WCDMA 2100 (Tx: 1920-1980 MHz Rx: 2110-2180 MHz); PCS1900 (1850-1990 MHz); UWB Lower (3100-4900 MHz); UWB Upper (6000-10600 MHz); DVB-H (470-702 MHz); DVB-H US (1670-1675 MHz); DRM (0.15-30 MHz); Wi Max (2300-2400 MHz, 2305-2360 MHz, 2496-2690 MHz, 3300-3400 MHz, 3400-3800 MHz, 5250-5875 MHz); DAB (174.928-239.2 MHz, 1452.96-1490.62 MHz); RFID LF (0.125-0.134 MHz); RFID HF (13.56-13.56 MHz); RFID UHF (433 MHz, 865-956 MHz, 2450 MHz). An operational frequency band is a frequency range over which an antenna/antenna array can efficiently operate. Efficient operation occurs, for example, when the antenna's/antenna array's insertion loss S11 is greater than an operational threshold such as 4 dB or 6 dB.

When in operation, the antenna array 18 has a radiation pattern 30 having a main lobe 32. The radiation pattern 30 indicates the directional efficiency of the antenna array 18 in receiving and/or transmitting electromagnetic signals. The radiation pattern 30 is formed through constructive and destructive interference from the combination of the plurality of antennas 18₁, 18₂, 18₃, 18₄. In order to maintain the clarity of FIG. 1, the radiation pattern 30 is illustrated as being two dimensional. However, it should be appreciated that the radiation pattern 30 of an antenna array 18 is usually three dimensional.

The main lobe 32 of the radiation pattern 30 is the portion of the radiation pattern 30 having the greatest efficiency for receiving and/or transmitting electromagnetic signals. In some embodiments, the radiation pattern 30 may have a single main lobe and in other embodiments, the radiation pattern 30 may have more than one main lobe. The use of a main lobe to transmit signals to, and receive signals from another apparatus, is usually called ‘beam forming’ in the art of radio frequency communications.

The orientation and size of the main lobe 32 of the radiation pattern 30 may be controlled, at least partially, by changing at least one parameter. The orientation of the main lobe 32 may be changed by changing the phase coefficient at the transceiver 16 (the phase coefficient sets the phase difference applied to signals received from/provided to each of the plurality of antennas 18₁, 18₂, 18₃, 18₄). The size of the main lobe 32 may be changed by changing the amplitude coefficient at the transceiver 16 (the amplitude coefficient sets the amplitude of signals received from/provided to each of the plurality of antennas 18₁, 18₂, 18₃, 18₄).

FIG. 1 also illustrates another apparatus 34 which may be any wireless communication apparatus such as a base station, a repeater or a portable electronic device (e.g. a mobile cellular telephone). The apparatus 34 may have the same electronic components as, or similar electronic components to, the apparatus 10. The apparatus 34 is located at a location which is in ‘line of sight’ of the antenna array 18 and has a bearing of θ from the antenna array 18.

The information 28 stored in the memory 14 includes the position (latitude, longitude and height above sea level) of the apparatus 34 and may also include the distance of the apparatus 34 from the antenna array 18. The information 28 for the apparatus 34 may be pre-stored in the memory 14 or may be provided to the apparatus 10 via a computer readable storage medium or may be included in a signal transmitted from the apparatus 34 itself.

The processor 12 may use the information 28 to calibrate the transceiver 16 and thereby increase the efficiency of transmission/reception at the apparatus 10. This will be explained in more detail in the following paragraphs with reference to FIGS. 2 and 3.

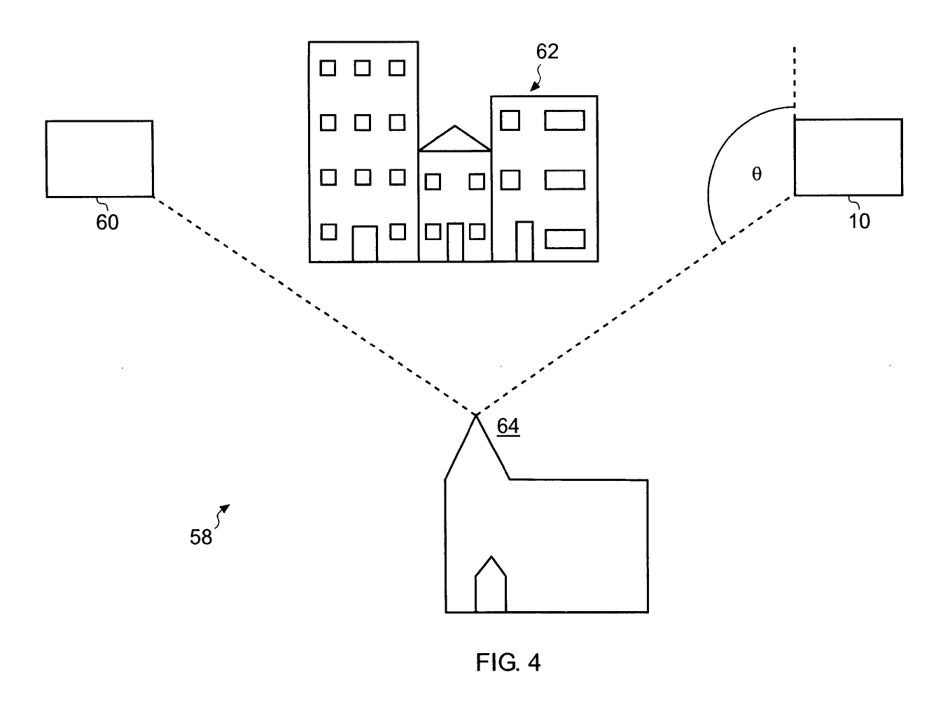

FIG. 2 illustrates a flow diagram of a method of calibrating a receiver 16 according to various embodiments of the present invention. The method is described with reference to FIG. 1. However, it should be appreciated that the method may be applied to other arrangements of apparatus (such as those illustrated in FIGS. 4, 5 and 6).

At block 36, the processor 12 determines a direction of the apparatus 34 relative to the antenna array 18 using the information 28, stored in the memory 14, for the apparatus 34. In FIG. 1, the direction of the apparatus 34 from the antenna array 18 is at a bearing 8 (azimuth angle in a spherical polar coordinate system). Since the apparatus 34 may be at a different height above sea level to the antenna array 18, the subsequent angle between them arising from their different heights (zenith angle in a spherical polar coordinate system) is also determined for the direction. In the art of radio communication, the above mentioned direction is usually referred to as the ‘direction of arrival’ (DoA).

At block 38, the processor 12 calculates one or more parameters for controlling the main lobe 32 of the radiation pattern 30, the calculation using the direction determined in block 36. In more detail, the processor 12 calculates phase coefficients for the receiver 16 that would, if applied at the receiver 16, substantially orient the main lobe 32 along the direction determined in block 36. In various embodiments, the processor 12 may also determine amplitude coefficients using information 28 for the distance of the apparatus 34 from the antenna array 18. It should be appreciated that the phase and amplitude coefficients calculated in block 38 represent expected or theoretical coefficients that are calculated using the information 28 stored in the memory 14.

At block 40, the processor 12 determines phase coefficients for the receiver 16 from a signal received at the antenna array 18 and transmitted from the apparatus 34. The processor 12 may also determine amplitude coefficients for the receiver 16 from the signal received at the antenna array 18. It should be appreciated that the phase and amplitude coefficients determined in block 40 are coefficients that are measured from a received signal.

At block 42, the processor 12 determines an offset by comparing the coefficients calculated in block 38 with the coefficients measured in block 40. The determined offset may represent the difference between the expected/theoretical coefficients (e.g. expected/theoretical phase and amplitude coefficients) and the measured coefficients (e.g. measured phase and amplitude coefficients). The determined offset may also represent systematic errors that are introduced to the received signal from the receiver 16 and/or the antenna array 18. If the antenna array 18 response is known, the processor 12 may determine the offset introduced to the signal by the receiver 16 using the determined offset.

At block 44, the processor 12 calibrates the receiver 16 using the offset determined in block 42. For example, in subsequent communications the processor 12 may apply the determined offset to calculated coefficients to improve the reception of a received signal.

FIG. 3 illustrates a flow diagram of a method of calibrating a transmitter 16 according to various embodiments of the present invention. The method is described with reference to FIG. 1. However, it should be appreciated that the method may be applied to other arrangements of apparatus (such as those illustrated in FIGS. 4, 5 and 6).

At block 46, the processor 12 determines a direction of the apparatus 34 relative to the antenna array 18 (the ‘direction of arrival’) using the information 28, stored in the memory 14, for the apparatus 34.

At block 48, the processor 12 calculates one or more parameters for controlling the main lobe 32 of the radiation pattern 30, the calculation using the direction determined in block 36. In more detail, the processor 12 calculates phase coefficients for the transmitter 16 that would, if applied to the transmitter 16, substantially orient the main lobe 32 along the direction determined in block 36. In various embodiments, the processor 12 may also determine amplitude coefficients using information 28 for the distance of the apparatus 34 from the antenna array 18. It should be appreciated that the phase and amplitude coefficients calculated in block 38 represent expected or theoretical coefficients that are calculated using the information 28 stored in the memory 18.

At block 50, the processor 12 directs the main lobe 32 of the radiation pattern 30 in a plurality of directions during transmission of a signal to the apparatus 34.

The apparatus 34 receives the signal transmitted from the antenna array 18 and then transmits a signal in reply which includes information indicating received signal strength at the apparatus 34 for substantially each of the plurality of directions. In various embodiments, the apparatus 10 may transmit a signal to the apparatus 34 requesting the apparatus 34 to transmit the received signal strength information.

At block 52, the processor 12 determines phase coefficients for the transmitter 16 using the signal transmitted from the apparatus 34. In particular, the processor 12 determines which direction of the plurality of directions has the highest received signal strength and then calculates phase coefficients for that direction. The processor 12 may also determine amplitude coefficients for the transmitter 16 from the signal received at the antenna array 18.

At block 54, the processor 12 determines an offset by comparing the coefficients calculated in block 48 (e.g. expected/theoretical phase and amplitude coefficients) with the coefficients measured in block 52 (e.g. measured phase and amplitude coefficients). The determined offset may represent the difference between the expected/theoretical coefficients and the measured coefficients. The determined offset may also represent systematic errors that are introduced to the transmitted signal from the transmitter 16 and/or the antenna array 18. If the antenna array 18 response is known, the processor 12 may determine the offset introduced to the signal by the transmitter 16 using the determined offset.

At block 56, the processor 12 calibrates the transmitter 16 using the offset determined in block 54. For example, in subsequent communications the processor 12 may apply the determined offset to calculated coefficients to improve the transmission of a signal.

Embodiments of the present invention may provide an advantage in that they enable a transceiver to be calibrated without requiring dedicated calibration hardware. Since dedicated calibration hardware is relatively expensive, embodiments of the present invention may reduce the cost of calibrating a transceiver.

Furthermore, embodiments of the present invention may provide an advantage by improving the transmission and/or reception efficiency of the apparatus 10. Additionally, embodiments of the present invention may reduce interference within the communication range (i.e. the cell) of the apparatus 10 since the main lobe 32 of the apparatus 10 may be more accurately oriented in a particular direction.

The methods described above with reference to FIGS. 2 and 3 may be used to in an initial calibration of the apparatus 10 and may also be used in a subsequent fine tuning calibration.

In one embodiment, for an initial calibration one or more of the methods described with reference to FIGS. 2 and 3 may be performed for a subset of adjacent antennas (e.g. two adjacent antennas such as antennas 18₁ and 18₂) in the antenna array 18. Then, one or more of the methods may be performed for a different subset of adjacent antennas (e.g. two different adjacent antennas such as antennas 18₃ and 18₄) of the antenna array 18. Optionally, one or more of the methods may be performed to calibrate the combination of the subsets of the antenna array. The one or more methods are repeated until they have been performed for substantially all antennas in the antenna array 18. The determined offsets for each antenna may then be used to initially calibrate the transceiver 16.

In another embodiment, for an initial calibration one or more of the methods described with reference to FIGS. 2 and 3 may be performed for a subset of adjacent antennas (e.g. two adjacent antennas such as antennas 18₁ and 18₂) in the antenna array 18 to determine their offset. Then, one or more of the methods may be performed for the previously selected subset of antennas (i.e. antennas 18₁ and 18₂) and an additional subset of adjacent antennas (which may be one or more antennas such as antenna 18₃) to determine an offset for the additional subset of adjacent antennas. Then, one or more of the methods may be performed for the previously selected subset of antennas (i.e. antennas 18₁, 18₂, 18₃) and an additional adjacent subset of antennas (which may be one or more antennas such as antenna 18₄) to determine an offset for the additional subset of adjacent antennas. The methods are repeated until they have been performed for substantially all of the antennas in the antenna array 18.

The above initial calibration methods may provide a number of advantages. For example, they may be less computationally intensive for the processor 12 than calibrating all antennas in the antenna array simultaneously.

In one embodiment for fine tuning the calibration of the antenna array 18 (with reference to FIGS. 2 and 3), the processor 12 directs the main lobe 32 in a plurality of directions that are centred on the direction determined in blocks 36 and 46 for transmission/reception of a signal in blocks 40 and 50. For example, if the processor 12 determines in blocks 36 and 46 that the direction of the apparatus 34 is 70°, the processor 12 in blocks 40 and 50 may direct the main lobe 32 in the directions 68°, 69°, 70°, 71° and 72°.

FIG. 4 illustrates a schematic diagram of a system 58 including an apparatus 10 according to various embodiments of the present invention and a further apparatus 60. The further apparatus 60 may be any electronic communication device and may be a base station, a repeater or a portable electronic device such as a mobile cellular telephone. A plurality of buildings 62 are positioned within the communication range of the antenna array 18 of the apparatus 10. A further building is located at a location 64 which may act as a location of reflection for radio frequency signals.

The buildings 62 are located between the apparatus 10 and the further apparatus 60 and consequently, the apparatus 60 is not in the ‘line of sight’ of the antenna array 18 of the apparatus 10. However, the apparatus 10 and the further apparatus 60 are able to communicate with one another by transmitting signals toward the building at the location 64 which reflects the signal onwards to the destination apparatus.

In this example, the memory 14 of the apparatus 10 stores information regarding the position of the location 64 and the processor 12 may calibrate the transceiver 16 by transmitting signals to, and receiving signals from the location 64 and following the methods described above with reference to FIGS. 2 and 3.

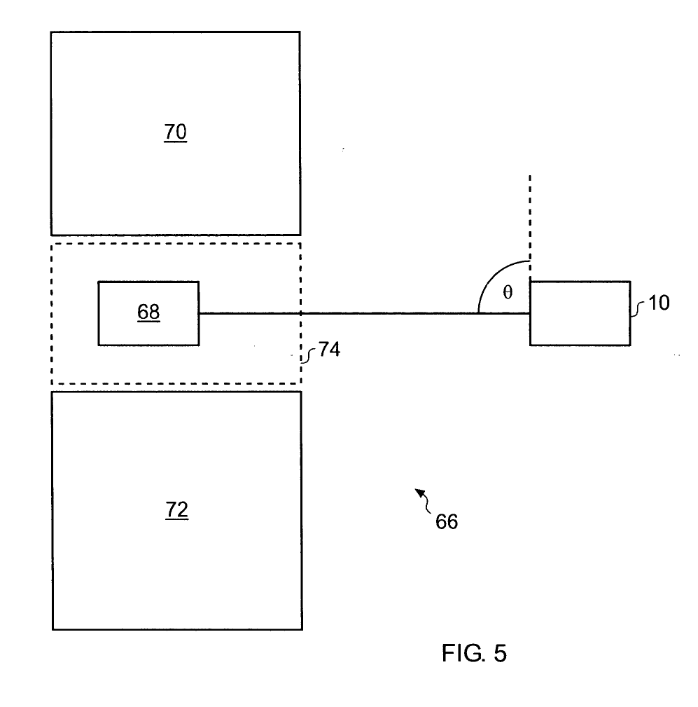

FIG. 5 illustrates a schematic diagram of another system 66 including an apparatus 10 according to various embodiments of the present invention and a further apparatus 68. The further apparatus 68 may be any portable electronic communication device such as a mobile cellular telephone that includes a location sensor (for example, a GPS receiver).

Buildings 70, 72 are positioned within the communication range of the antenna array 18 (i.e. the cell of the apparatus 10) and consequently restrict the ‘line of sight’ of the antenna array 18. The buildings 70, 72 define an area 74 (denoted by a dotted line in FIG. 5) that is in the ‘line of sight’ of the antenna array 18.

The apparatus 68 is configured to transmit a signal to the apparatus 10 including information regarding the position of the apparatus 68 (obtained via the location sensor). When the apparatus 10 receives the signal from the apparatus 68, the processor 12 of the apparatus 10 compares the information received from the apparatus 68 with the information 28 stored in the memory 14 and determines whether the apparatus 68 is in the ‘line of sight’ of the antenna array 18 (i.e. whether it is located in the area 74). If the apparatus 68 is in the ‘line of sight’ of the antenna array 18, the processor 12 may calibrate the transceiver 16 using the methods described above with reference to FIGS. 2 and 3.

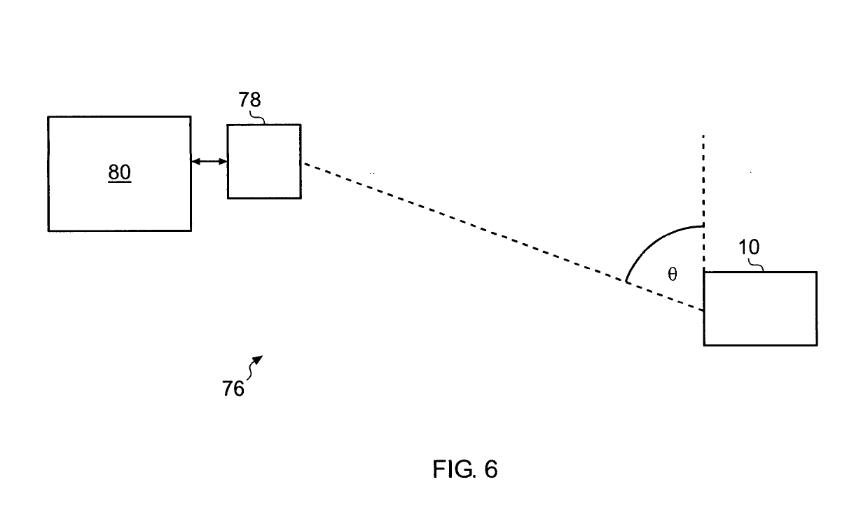

FIG. 6 illustrates a schematic diagram of another system 76 including an apparatus 10 according to various embodiments of the present invention and a further apparatus 78. The further apparatus 78 may be any portable electronic communication device such as a mobile cellular telephone. The system 76 also includes an access point 80 that is installed at a location that is in the line of sight of the antenna array 18 of the apparatus 10. The access point 80 and/or the further apparatus 78 are configured to determine when the further apparatus 78 is in relatively close proximity to the access point 80, and then transmit a signal to the apparatus 10 including information indicating that a signal is receivable at the access point 80 and that the processor 12 may calibrate the transceiver 16 using the methods described above with reference to FIGS. 2 and 3.

For example, the access point 80 may include a radio frequency identification (RFID) reader which is configured to recognize portable electronic devices that are equipped with RFID tags and inform the apparatus 10 accordingly for calibration (e.g. via a landline connection). Alternatively, the access point 80 may include an RFID tag and the further apparatus 78 may include an RFID reader. In this embodiment, the further apparatus 78 informs the apparatus 10 that calibration may commence. In another example, the access point 80 may recognize the further apparatus 78 using a low powered radio frequency network such as Bluetooth and the access point 80 and/or the further apparatus 78 may inform the apparatus 10 that calibration may commence. In yet another example, the access point 80 may recognize the further apparatus 78 using a wireless computer network such as Wireless LAN or WiMax and the access point and/or the further apparatus 78 may inform the apparatus 10 that calibration may commence.

The blocks illustrated in the FIGS. 2 and 3 may represent steps in a method and/or sections of code in the computer program 28. The illustration of a particular order to the blocks does not necessarily imply that there is a required or preferred order for the blocks and the order and arrangement of the block may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed. For example, the information 28 relating to another apparatus may not be pre-stored in the memory 14, but may instead be transmitted from the other apparatus. In these embodiments, the method blocks of determining a direction of a location and then determining a parameter from the determined direction may be performed after the block of determining a parameter from a received signal. For example, in FIG. 2, blocks 36 and 38 may be performed after block 40 and in FIG. 3, blocks 46 and 48 may be performed after block 52.

In various embodiments, the antenna array 18 may be positioned remote from a base station and may be connected to the base station via a communication link (e.g. optical cables). In these embodiments, the processor 12 may be located at the antenna array 18 and/or at the base station.

During initial calibration, the methods described with reference to FIGS. 2 and 3 may be carried out for antennas which are not adjacent and which may be irregularly spaced relative to one another.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1-53. (canceled)

54. A method comprising:
calculating a parameter for controlling a main lobe of a radiation pattern of an antenna array, the calculation using a direction of a location relative to the antenna array, the direction determined from information including a position of the location;
determining a parameter for controlling the main lobe of the radiation pattern of the antenna array from a signal received at the antenna array from the location; and
determining an offset using the parameter calculated from the determined direction and the parameter determined from the received signal.

55. A method as claimed in claim 54, further comprising determining the direction of the location relative to the antenna array, using the information including the position of the location.

56. A method as claimed in claim 54, further comprising calibrating an apparatus using the determined offset.

57. A method as claimed in claim 54, further comprising calibrating a receiver using the determined offset.

58. A method as claimed in claim 54, further comprising directing the main lobe of the radiation pattern in a plurality of directions during transmission of a signal to a further apparatus.

59. A method as claimed in claim 58, wherein the received signal includes information indicating received signal strength at the further apparatus for substantially each of the plurality of directions and wherein the parameter determined from the received signal is associated with the direction having the highest received signal strength.

60. A method as claimed in claim 59, further comprising calibrating a transmitter using the determined offset.

61. A method as claimed in claim 54, wherein a further apparatus is located at the location.

62. A method as claimed in claim 55, wherein the signal received at the antenna array is reflected at the location.

63. A method as claimed in claim 54, further comprising receiving a signal including information indicating that a signal is receivable from the location.

64. A method as claimed in claim 54, further comprising receiving a signal comprising the information including the position of the location at the antenna array.

65. A method as claimed in claim 54, further comprising performing the steps of claim 54 for at least two antennas of the antenna array.

66. A method as claimed in claim 65, further comprising performing the steps of claim 54 for at least another two antennas of the antenna array and repeating said steps until the steps have been performed for substantially all antennas in the antenna array.

67. A method as claimed in claim 65, further comprising performing the steps of claim 54 for the at least two antennas of the antenna array and at least one other antenna of the antenna array.

68. A method as claimed in claim 66, further comprising performing an initial calibration of the apparatus using the determined offsets.

69. An apparatus comprising:
at least one processor;
at least one memory including computer program code; the at least one memory and the computer program code configured to, with the at least one processor, cause the apparatus at least to perform:
calculating a parameter, for controlling a main lobe of a radiation pattern of an antenna array, using a direction of a location relative to the antenna array, the direction determined from information including a position of the location;
determining a parameter for controlling the main lobe of the radiation pattern of the antenna array from a signal received at the antenna array from the location; and
determining an offset using the parameter calculated from the determined direction and the parameter determined from the received signal.

70. An apparatus as claimed in claim 69, wherein the at least one memory and the computer program code configured to, with the at least one processor, cause the apparatus at least to perform determining the direction of the location relative to the antenna array, using the information including the position of the location.

71. An apparatus as claimed in claim 69, wherein the at least one memory and the computer program code configured to, with the at least one processor, cause the apparatus at least to perform calibrating the apparatus using the determined offset.

72. A module or an electronic device comprising an apparatus as claimed in claim 69.

73. A computer readable storage medium encoded with instructions that, when executed by a processor, perform:
calculating a parameter for controlling a main lobe of a radiation pattern of an antenna array, the calculation using a direction of a location relative to the antenna array, the direction determined from information including a position of the location;
determining a parameter for controlling the main lobe of the radiation pattern of the antenna array from a signal received at the antenna array from the location; and
determining an offset using the parameter calculated from the determined direction and the parameter determined from the received signal.
